(19) United States
(12) Patent Application Publication
(10) Pub. No.: US 2006/0015659 A1
(43) Pub. Date: Jan. 19, 2006

(54) System and method for transferring data using storage controllers

(76) Inventors: Leon A. Krantz, Mission Viejo, CA (US); Kha Nguyen, Anaheim, CA (US); Huy T. Nguyen, Laguna Hills, CA (US)

Correspondence Address: KLEIN, O'NEILL & SINGH, 2 PARK PLAZA, SUITE 510, IRVINE, CA, 92614, US

(21) Appl. No.: 10/893,822

(22) Filed: Jul. 19, 2004

(51) Int. Cl. G06F 3/00

(52) U.S. Cl. 710/52

(57) ABSTRACT

A method and a storage controller for transferring data between a host and a storage device is provided. The storage controller includes, a transport module having a first in first out (“FIFO”) for receiving frames from a link module, wherein the FIFO uses two pointers; the first pointer points to a location of a frame that is received with cyclic redundancy code (“CRC”) and the second pointer points to the frame after the CRC is verified and the frame is acceptable. The method includes, using a first pointer to point to a location when a frame arrives without the CRC; and verifying the CRC and if a frame is acceptable using a second pointer to point to the first pointer location. If a frame is corrupt the first pointer and the second pointer point to a location of a receive pointer.

### BACKGROUND OF THE INVENTION

1. Field of the Invention

The present invention relates generally to storage device controllers, and more particularly, to efficiently manage data flow in a receive path.

2. Background

Conventional computer systems typically include several functional components. These components may include a central processing unit (CPU), main memory, input/output (“I/O”) devices, and streaming storage devices (for example, tape drives/disks) (referred to herein as “storage device”).

In conventional systems, the main memory is coupled to the CPU via a system bus or a local memory bus. The main memory is used to provide the CPU access to data and/or program information that is stored in main memory at execution time. Typically, the main memory is composed of random access memory (RAM) circuits. A computer system with the CPU and main memory is often referred to as a host system.

The storage device is coupled to the host system via a controller that handles complex details of interfacing the storage device to the host system. Communications between the host system and the controller is usually provided using one of a variety of standard I/O bus interfaces.

Typically, when data is read from a storage device, a host system sends a read command to the controller, which stores the read command into a buffer memory. Data is read from the device and stored in the buffer memory.

Various standard interfaces are used to move data from host systems to storage devices. Fibre channel is one such standard. Fibre channel (incorporated herein by reference in its entirety) is an American National Standard Institute (ANSI) set of standards, which provides a serial transmission protocol for storage and network protocols such as HIPPI, SCSI, IP, ATM and others. Fibre channel provides an input/output interface to meet the requirements of both channel and network users.

Host systems often communicate with storage systems using the standard “PCI” bus interface. PCI stands for Peripheral Component Interconnect, a local bus standard that was developed by Intel Corporation®. The PCI standard is incorporated herein by reference in its entirety. Most modern computing systems include a PCI bus in addition to a more general expansion bus (e.g. the ISA bus). PCI is a 64-bit bus and can run at clock speeds of 33 or 66 MHz.

PCI-X is a standard bus that is compatible with existing PCI cards using the PCI bus. PCI-X improves the data transfer rate of PCI from 132 MBps to as much as 1 GBps. The PCI-X standard (incorporated herein by reference in its entirety) was developed by IBM®, Hewlett Packard Corporation® and Compaq Corporation® to increase performance of high bandwidth devices, such as Gigabit Ethernet standard and Fibre Channel Standard, and processors that are part of a cluster.

The iSCSI standard (incorporated herein by reference in its entirety) is based on Small Computer Systems Interface (“SCSI”), which enables host computer systems to perform block data input/output (“I/O”) operations with a variety of peripheral devices including disk and tape devices, optical storage devices, as well as printers and scanners.

A traditional SCSI connection between a host system and peripheral device is through parallel cabling and is limited by distance and device support constraints. For storage applications, iSCSI was developed to take advantage of network architectures based on Fibre Channel and Gigabit Ethernet standards. iSCSI leverages the SCSI protocol over established networked infrastructures and defines the means for enabling block storage applications over TCP/IP networks. iSCSI defines mapping of the SCSI protocol with TCP/IP. The iSCSI architecture is based on a client/server model. Typically, the client is a host system such as a file server that issues a read or write command. The server may be a disk array that responds to the client request.

Serial ATA (“SATA”) is another standard, incorporated herein by reference in its entirety that has evolved from the parallel ATA interface for storage systems. SATA provides a serial link with a point-to-point connection between devices and data transfer can occur at 150 megabytes per second.

Another standard that has been developed is Serial Attached Small Computer Interface (“SAS”), incorporated herein by reference in its entirety. The SAS standard allows data transfer between a host system and a storage device. SAS provides a disk interface technology that leverages SCSI, SATA, and fibre channel interfaces for data transfer. SAS uses a serial, point-to-point topology to overcome the performance barriers associated with storage systems based on parallel bus or arbitrated loop architectures.

Conventional controllers in the SAS environment use a first in first out (“FIFO”) staging memory for temporarily holding data, before data is sent to its proper location. When a frame is received, it is very difficult to determine whether the frame is error free or not. Therefore, a transport module that is used to move frames often receives a bad frame without knowing it is a bad frame, processes through the bad frame and then discards the bad frame. This system and technique is cumbersome and results in latency causing degradation in the overall system performance.

Therefore, there is a need for a system and method to efficiently manage the FIFO so that the transport module can move frames without causing unnecessary latency and delay.

### SUMMARY OF THE INVENTION

In one aspect of the present invention, a storage controller for transferring data between a host and a storage device is provided. The storage controller includes: a transport module having a first in first out (“FIFO”) for receiving frames from a link module, wherein the FIFO uses two pointers; the first pointer points to a location of a frame that is received with cyclic redundancy code (“CRC”) and the second pointer points to the frame after CRC is verified and the frame is acceptable.

The transport module only processes acceptable frames since the second pointer is not loaded if the CRC is found to be corrupt. The first and second pointers point to a location of a receive pointer if the frame is corrupt.

In yet another aspect of the present invention, a method for processing frames in a first in first out (“FIFO”) staging memory of a transport module in a storage controller is provided. The method includes using a first pointer to point to a location when a frame arrives without cyclic redundancy code (“CRC”); and verifying the CRC and if the frame is acceptable using a second pointer to point to the first pointer location. If a frame is corrupt, then the first and second pointers point to a location of a receive pointer.

In yet another aspect of the present invention, a transport module in a storage controller is provided. The transport module includes a first in first out (“FIFO”) for receiving frames from a link module, wherein the FIFO uses two pointers; the first pointer points to a location of a frame that is received with cyclic redundancy code (“CRC”) and the second pointer points to the frame after CRC is verified and the frame is acceptable.

This brief summary has been provided so that the nature of the invention may be understood quickly. A more complete understanding of the invention can be obtained by reference to the following detailed description of the preferred embodiments thereof concerning the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following Figures:

FIG. 1A shows an example of a storage drive system used with the adaptive aspects of the present invention;

FIG. 1B shows a block diagram of a SAS module used in a controller, according to one aspect of the present invention;

FIG. 1C shows a detailed block diagram of a SAS module, according to one aspect of the present invention;

FIG. 1D shows a SAS frame that is received/transmitted using the SAS module according to one aspect of the present invention;

FIGS. 2A-2D show the use of pointers, according to one aspect of the present invention; and

FIG. 3 shows a flow diagram for using pointers, according to one aspect of the present invention.

### DETAILED DESCRIPTION OF THE PREFERRED EMBODIMENTS

Controller Overview:

To facilitate an understanding of the preferred embodiment, the general architecture and operation of a controller will initially be described. The specific architecture and operation of the preferred embodiment will then be described with reference to the general architecture.

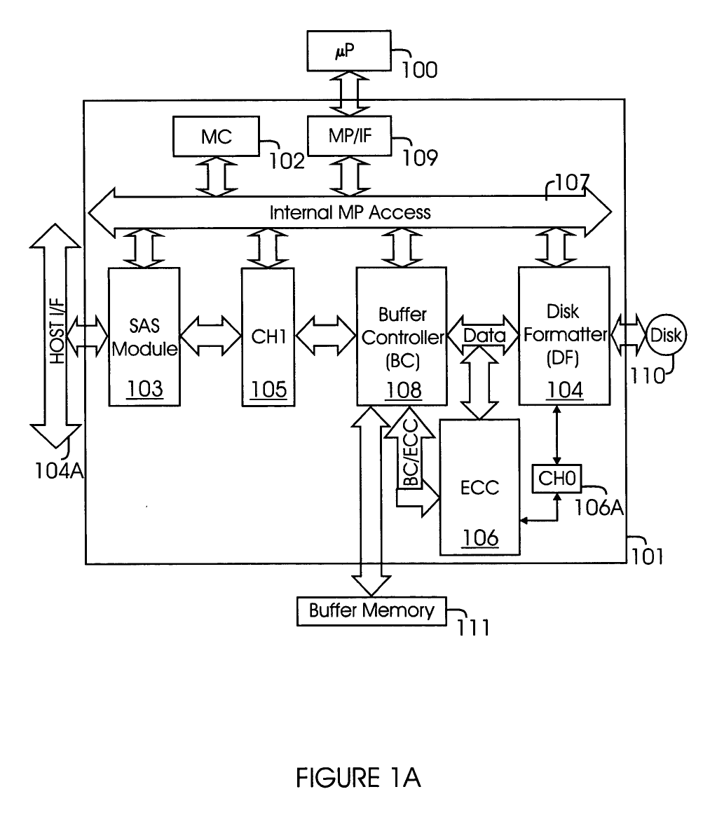

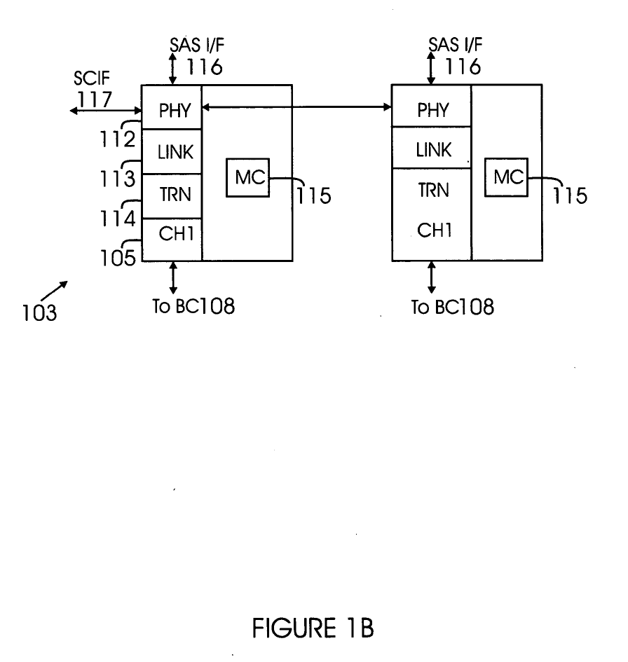

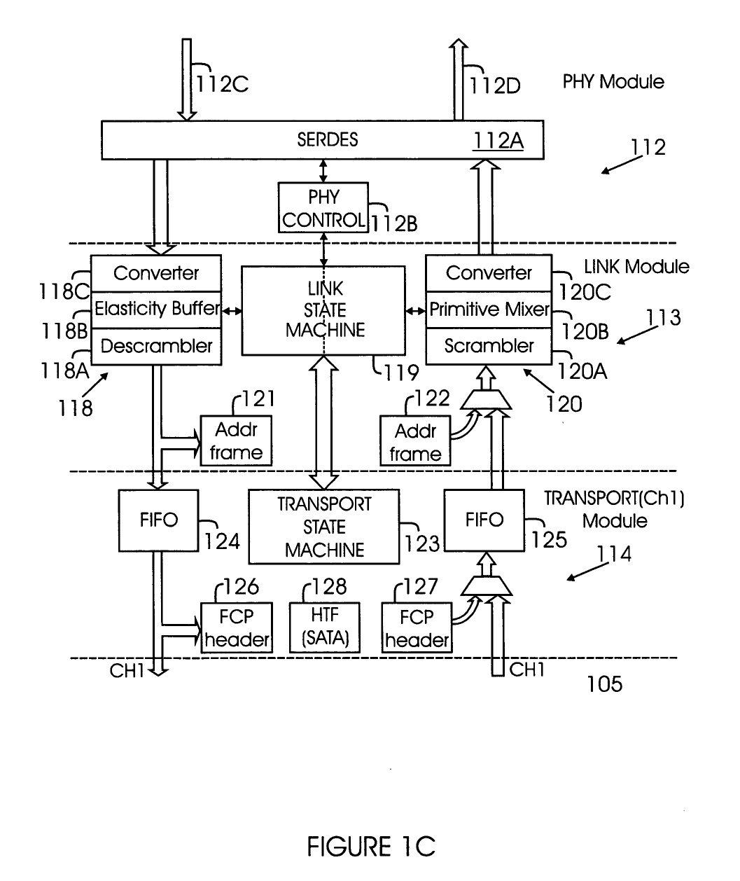

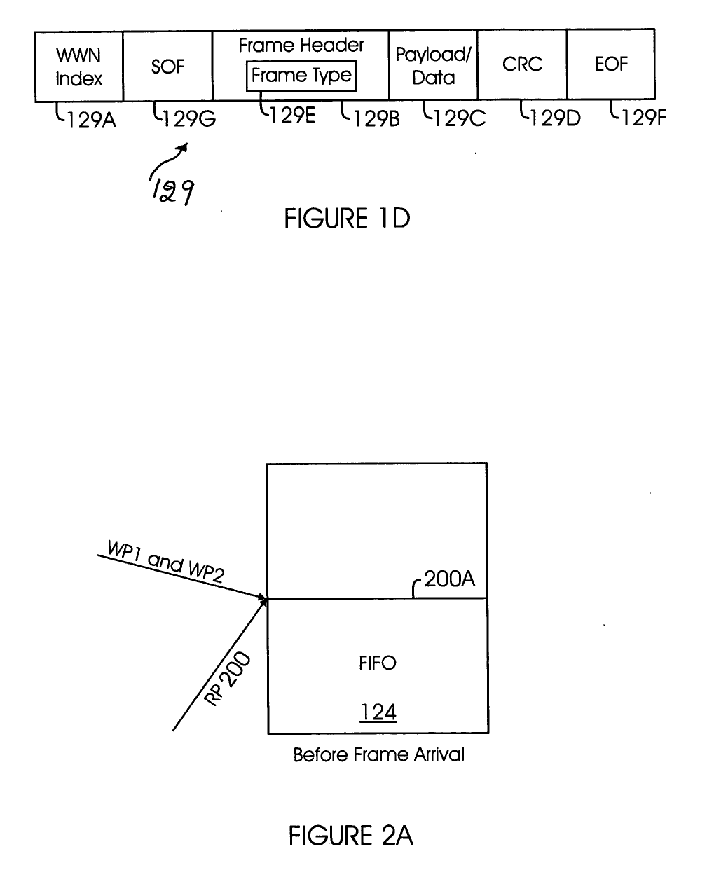

FIG. 1A shows an example of a storage drive system (with an optical disk or tape drive), included in (or coupled to) a computer system. The host computer (not shown) and the storage device 110 (also referred to as disk 110) communicate via a port using a disk formatter “DF” 104. In an alternate embodiment (not shown), the storage device 110 is an external storage device, which is connected to the host computer via a data bus. The data bus, for example, is a bus in accordance with a Small Computer System Interface (SCSI) specification. Those skilled in the art will appreciate that other communication buses known in the art can be used to transfer data between the drive and the host system.

As shown in FIG. 1A, the system includes controller 101, which is coupled to buffer memory 111 and microprocessor 100. Interface 109 serves to couple microprocessor bus 107 to microprocessor 100 and a micro-controller 102 and facilitates transfer of data, address, timing and control information. A read only memory (“ROM”) omitted from the drawing is used to store firmware code executed by microprocessor 100.

Controller 101 can be an integrated circuit (IC) that comprises of various functional modules, which provide for the writing and reading of data stored on storage device 110. Buffer memory 111 is coupled to controller 101 via ports to facilitate transfer of data, timing and address information. Buffer memory 111 may be a double data rate synchronous dynamic random access memory (“DDR-SDRAM”) or synchronous dynamic random access memory (“SDRAM”), or any other type of memory.

Disk formatter 104 is connected to microprocessor bus 107 and to buffer controller 108. A direct memory access (“DMA”) DMA interface (not shown) is connected to microprocessor bus 107 and to data and control port (not shown).

Buffer controller (also referred to as “BC”) 108 connects buffer memory 111, channel one (CH1) logic 105, error correction code (“ECC”) module 106 to bus 107. Buffer controller 108 regulates data movement into and out of buffer memory 111.

CH1 logic 105 is functionally coupled to SAS module 103 that is described below in detail. CH1 Logic 105 interfaces between buffer memory 111 and SAS module 103. SAS module 103 interfaces with host interface 104A to transfer data to and from disk 110.

Data flow between a host and disk passes through buffer memory 111 via channel 0 (CH0) logic 106A. ECC module 106 generates ECC that is saved on disk 110 during a write operation and provides correction mask to BC 108 for disk 110 read operation.

The channels (CHO 106A and CH1 105 and Channel 2 (not shown) are granted arbitration turns when they are allowed access to buffer memory 111 in high speed burst write or read operations for a certain number of clocks. The channels use first-in-first out (“FIFO”) type memories to store data that is in transit. Firmware running on processor 100 can access the channels based on bandwidth and other requirements.

To read data from device 110, a host system sends a read command to controller 101, which stores the read commands in buffer memory 111. Microprocessor 100 then reads the command out of buffer memory 111 and initializes the various functional blocks of controller 101. Data is read from device 110 and is passed to buffer controller 108.

To write data, a host system sends a write command to disk controller 101, which is stored in buffer 111. Microprocessor 100 reads the command out of buffer 111 and sets up the appropriate registers. Data is transferred from the host and is first stored in buffer 111, before being written to disk 110. CRC (cyclic redundancy check code) values are calculated based on a logical block address (“LBA”) for the sector being written. Data is read out of buffer 111, appended with ECC code and written to disk 110.

Frame Structure:

FIG. 1D shows a SAS frame 129 that is received/transmitted using SAS module 103. Frame 129 includes a WWN value 129A, a start of frame (“SOF”) value 129G, a frame header 129B that includes a frame type field 129E, payload/data 129C, CRC value 129D and end of frame (“EOF”) 129F. The SAS specification addresses all devices by a unique World Wide Name (“WWN”) address.

Also, a frame may be an interlock or non-interlocked, specified by field 129E in frame header 129B. For an interlock frame, acknowledgement from a host is required for further processing, after the frame is sent to the host. Non-interlock frames are passed through to a host without host acknowledgement (up to 256 frames per the SAS standard).

SAS Module 103:

FIG. 1B shows a top level block diagram for SAS module 103 used in controller 101. SAS module 103 includes a physical (“PHY”) module 112, a link module 113 and a transport module (“TRN”) 114 described below in detail. A micro-controller 115 is used to co-ordinate operations between the various modules. A SAS interface 116 is also provided to the PHY module 112 for interfacing with a host and interface 117 is used to initialize the PHY module 112.

FIG. 1C shows a detailed block diagram of SAS module 103 with various sub-modules. Incoming data 112C is received from a host system, while outgoing data 112D is sent to a host system or another device/component.

PHY Module 112:

PHY module 112 includes a serial/deserializer (“SERDES”) 112A that serializes encoded data for transmission 112D, and de-serializes received data 112C. SERDES 112A also recovers a clock signal from incoming data stream 112C and performs word alignment.

PHY control module 112B controls SERDES 112A and provides the functions required by the SATA standard.

Link Module 113:

Link module 113 opens and closes connections, exchanges identity frames, maintains ACK/NAK (i.e. acknowledged/not acknowledged) balance and provides credit control. As shown in FIG. 1C, link module 113 has a receive path 118 that receives incoming frames 112C and a transmit path 120 that assists in transmitting information 112D. Addresses 121 and 122 are used for received and transmitted data, respectively.

Receive path 118 includes a converter 118C for converting 10-bit data to 8-bit data, an elasticity buffer/primitive detect segment 118B that transfers data from a receive clock domain to a transmit block domain and decodes primitives. Descrambler module 118A unscrambles data and checks for cyclic redundancy check code (“CRC”).

Transmit path 120 includes a scrambler 120A that generates CRC and scrambles (encodes) outgoing data; and primitive mixer module 120B that generates primitives required by SAS protocol/standard and multiplexes the primitives with the outgoing data. Converter 120C converts 8-bit data to 10-bit format.

Link module 113 uses plural state machines 119 to achieve the various functions of its sub-components. State machines 119 include a receive state machine for processing receive frames, a transmit state machine for processing transmit frames, a connection state machine for performing various connection related functions and an initialization state machine that becomes active after an initialization request or reset.

Transport Module 114:

Transport module 114 interfaces with CH1 105 and link module 113. In transmit mode, TRN module 114 receives data from CH1 105, loads the data (with fibre channel header (FCP) 127) in FIFO 125 and sends data to Link module 113 encapsulated with a header (129B) and a CRC value (129D). In receive mode, TRN module 114 receives data from link module 113 (in FIFO 124), and re-packages data (extracts header 126 and 128) before being sent to CH1 105. CH1 105 then writes the data to buffer 111. State machine 123 is used to co-ordinate data transfer in the receive and transmit paths.

Managing FIFO 124:

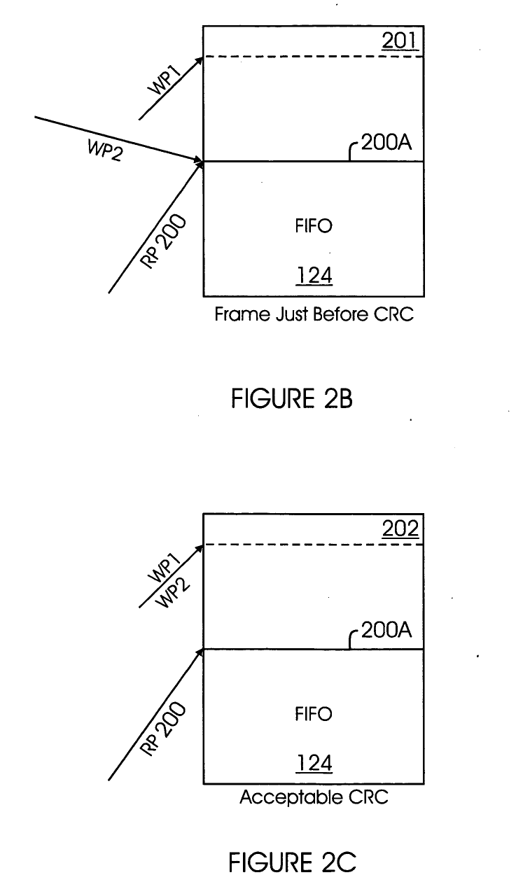

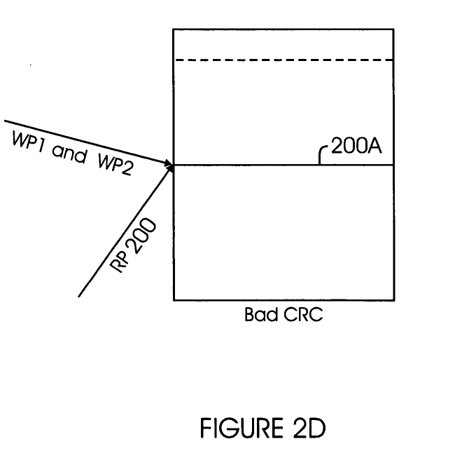

In one aspect of the present invention, FIFO 124 uses two pointers WP1 and WP2 shown in FIGS. 2A-2D. Pointer WP1 is advanced during FIFO frame upload. After CRC 129D is received, the frame is checked for errors. If the frame is found to be “good”, the content of WP1 is loaded into pointer WP2. If the frame is found to be “corrupted” (or bad), the content of WP2 is loaded into WP1. Only WP2 is visible to the Transport module 114 and the advancement of WP2 indicates “good” frame arrival. Since a “corrupt” frame does not advance WP2, the Transport module 114 is unaware of “bad” frames. Also, since WP2 advances only when an entire frame is in the FIFO, it eliminates the need for FIFO flow control and this reduces overall latency.

FIGS. 2A-2D illustrate the various stages of how pointers WP1 and WP2 are used for processing frames. FIG. 2A shows the stage before a frame is received by FIFO 124. At this stage, a receive pointer (“RP”) 200 points to a location 200A in FIFO 124 before a frame is received in FIFO 124. Pointers WP1 and WP2 also point to the same location as RP 200.

FIG. 2B shows the stage when a frame has just arrived (201) without CRC 129D. At this stage, pointer WP1 points to location 201, while pointer WP2 points to the original location 200A (i.e. of RP 200).

FIG. 2C shows the stage when the CRC 129D has been verified and the frame is found to be acceptable. At this stage, both WP1 and WP2 point to location 202. The frame is acceptable and processed out of FIFO 124 by transport module 114.

FIG. 2D shows the stage when CRC 129D has been checked and the frame is found to be corrupt. In this case the pointers WP1 and WP2 both point to RP 200 location 200A. The bad frame is written over by a good frame and the process starts over again.

As discussed above, when the frame is bad, WP2 is not advanced, and the transport module 114 is unaware of “bad” frames. Therefore, transport module does not waste time in processing through a frame and then finding that the frame is bad. This reduces latency and eliminates the need for complex flow control since only good frames are processed.

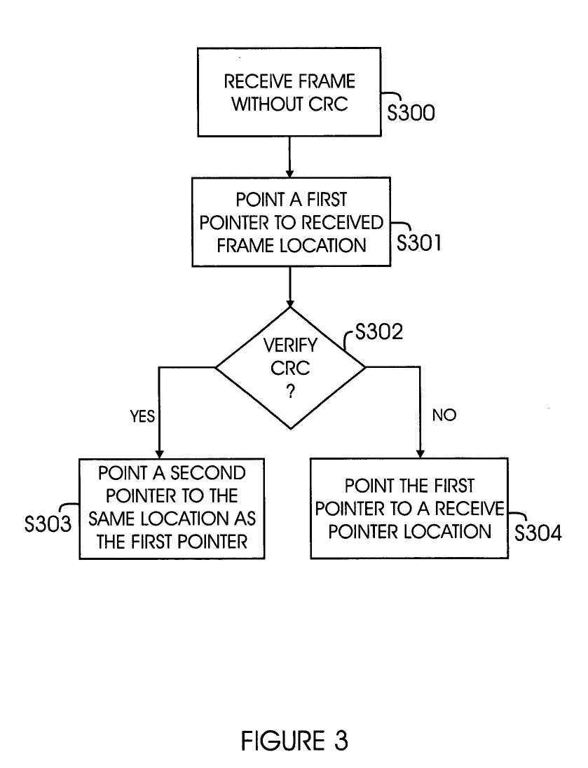

FIG. 3 shows a process flow diagram for using pointers WP1 and WP2, according to one aspect of the present invention.

In step S300, a frame is received without CRC 129D.

In step S301, pointer WP1 points to the received frames location 201.

In step S302, the CRC 129D is verified. If the frame is acceptable, then in step S303, the second pointer WP2 points to location 201, the same location as WP1. Thereafter, transport module 114 processes the frame.

If the frame is corrupt, then in step S304, the first pointer points to the original location (200A) and the frame is not processed.

Although the present invention has been described with reference to specific embodiments, these embodiments are illustrative only and not limiting. Many other applications and embodiments of the present invention will be apparent in light of this disclosure.

What is claimed is:

1. A storage controller for transferring data between a host and a storage device, comprising:
a transport module having a first in first out (“FIFO”) for receiving frames from a link module, wherein the FIFO uses a first pointer and a second pointer, and the first pointer points to a location of a frame that is received with cyclic redundancy code (“CRC”) while the second pointer points to the frame after CRC is verified and the frame is acceptable.

2. The storage controller of claim 1, wherein the transport module only processes acceptable frames since the second pointer is not loaded if the CRC is found to be corrupt.

3. The storage controller of claim 1, wherein the first pointer and the second pointer point to a location of a receive pointer if the frame is corrupt.

4. The storage controller of claim 3, wherein the first pointer and the second pointer point to the same location as the receive pointer before the CRC is received.

5. A method for processing frames in a first in first out (“FIFO”) staging memory of a transport module in a storage controller, comprising:
using a first pointer to point to a location when a frame arrives without a cyclic redundancy code (“CRC”); and
verifying the CRC and if frame is acceptable using a second pointer to point to the first pointer location.

6. The method of claim 5, wherein if a frame is corrupt the first and second pointer point to a location of a receive pointer.

7. A transport module in a storage controller comprising:
a first in first out (“FIFO”) for receiving frames from a link module, wherein the FIFO uses a first pointer and a second pointer, and the first pointer points to a location of a frame that is received with a cyclic redundancy code (“CRC”) and the second pointer points to the frame after the CRC is verified and the frame is acceptable.

8. The transport module of claim 7, wherein the transport module only processes acceptable frames since the second pointer is not loaded if the CRC is found to be corrupt.

9. The transport module of claim 7, wherein the first pointer and the second pointer point to a location of a receive pointer if the frame is corrupt.

10. The transport module of claim 9, wherein the first pointer and the second pointer point to the same location as the receive pointer before the CRC is received.
